(19) United States
(12) Patent Application Publication
(10) Pub. No.: US 2026/0135858 A1
(43) Pub. Date: May 14, 2026

(54) TIME-BASED EXPIRING USER IDENTIFIERS IN NETWORK-ACCESSIBLE SERVICES

(71) Applicant: NETFLIX, INC., Los Gatos, CA (US)

(72) Inventors: Andrew John SWEENEY, Brooklyn, NY (US); Aadesh D. PATEL, New York, NY (US); Simon Lloyd SPENCER, Sunnyvale, CA (US); Sophia Rosalind DONG, New York, NY (US); Edward Robin THOMAS, Los Angeles, CA (US)

(21) Appl. No.: 19/384,816

(22) Filed: Nov. 10, 2025

Related U.S. Application Data
(60) Provisional application No. 63/719,760, filed on Nov. 13, 2024.

(51) Int. Cl. H04L 9/40; H04L 67/306

(52) U.S. Cl. CPC H04L 63/108; H04L 67/306

(57) ABSTRACT

In various embodiments, a computer-implemented method for generating expiring user identifiers includes receiving an event-based identifier that uniquely identifies a user among a plurality of users, determining a time-to-live (TTL) based on the event-based identifier, generating a salt based on a current time and the TTL, providing, to a hash function, the event-based identifier and the salt to generate an expiring user identifier, and transmitting the expiring user identifier to at least one computing device to cause the at least one computing device, wherein the expiring user identifier obfuscates the event-based identifier from the at least one computing device and wherein a new expiring user identifier based on the event-based identifier has a same value as the expiring user identifier during at least a portion of the TTL.

### CROSS-REFERENCE TO RELATED APPLICATIONS

This application claims priority to U.S. Provisional Application No. 63/719,760, entitled “TIME-BASED IDENTIFIERS WITH CUSTOM DECAY RATE PARTITIONS,” filed Nov. 13, 2024. The subject matter of this related application is hereby incorporated herein by reference.

### BACKGROUND

### Field of the Various Embodiments

Embodiments of the present disclosure relate generally to network-accessible services and, more specifically, to time-based expiring user identifiers in network-accessible services.

### Description of the Related Art

Modern network-accessible services, such as streaming media services, typically identify users with unique user identifiers. A user identifier that is linked to a particular user or user account generally uniquely identifies the user or user account with respect to a group of users associated with the network-accessible service. For internal use within a secure environment, such as within the computing environment associated with the network-accessible service or among systems and entities that are trusted, using a transparent user identifier is often an acceptable practice. However, when interacting with systems and entities external to the network-accessible service, such as when a streaming media service programmatically interacts with third-party systems, sharing an identifier that uniquely identifies a user among a population of users risks breaching user privacy or exposing more information about the user than is desired. For example, an external system or actor, if given a user identifier within a network-accessible service, could potentially track the activity of the user within the external system. Even if no additional information other than an alphanumeric string that identifies the user is shared with the external system, the identity of the user might be known within the external system if the user also has a user account within the external system. Accordingly, the external system could then link the identity of the user with the user identifier shared by the network-accessible service.

In some situations, the operator of a network-accessible service might desire to share an identifier that identifies a user. However, given the privacy considerations, sharing a user identifier that permanently and uniquely identifies a user among a population of users carries significant privacy risk to a user population. Prior solutions to addressing the privacy concerns of a network-accessible service include generating a stateful temporary user identifier. With such a solution, a server generates a session for a user that includes a temporary user identifier. Data associated with the temporary user identifier, such as an expiration date of the temporary user identifier, must then be tracked or stored in a data store. Each time the temporary user identifier is used, the state of the temporary user identifier must be checked to determine whether the temporary user identifier is expired. Such a stateful approach imposes significant data storage and computational overheads. Other solutions involve encrypting a temporary user identifier to obscure the identifier from third party systems. However, encrypting the temporary user identifier imposes additional computational overhead due to the need to perform cryptographic operations as well as maintain encryption and/or decryption keys.

As the foregoing illustrates, what is needed in the art are improved techniques for temporarily identifying a user of a network-accessible service to systems external to the service while also protecting user privacy.

### SUMMARY

In various embodiments, a computer-implemented method for generating expiring user identifiers includes receiving an event-based identifier that uniquely identifies a user among a plurality of users, determining a time-to-live (TTL) based on the event-based identifier, generating a salt based on a current time and the TTL, providing, to a hash function, the event-based identifier and the salt to generate an expiring user identifier, and transmitting the expiring user identifier to at least one computing device to cause the at least one computing device, wherein the expiring user identifier obfuscates the event-based identifier from the at least one computing device and wherein a new expiring user identifier based on the event-based identifier has a same value as the expiring user identifier during at least a portion of the TTL.

At least one technical advantage of the disclosed techniques relative to the prior art is that the disclosed techniques enable a network-accessible service to generate an expiring user identifier that remains consistent across multiple requests or within a given time window. Additionally, the expiring user identifier also obfuscates the identity of a user or a user identifier associated with the user. Another technical advantage of the disclosed techniques is that such techniques provide a stateless mechanism to generate expiring user identifiers without requiring the tracking of user identifier states in a database or other data store. A stateless mechanism for generating expiring user identifiers reduces both the computational overhead and the data storage requirements of the network-accessible service. Reducing computational overhead and data storage requirements offers significant technical advantages, particularly in systems or services that involve a large user base.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments;

FIG. 4 is a more detailed block diagram of the endpoint device of FIG. 1, according to various embodiments;

FIG. 5 illustrates an example of how control application can generate an expiring user identifier, according to various embodiments;

FIG. 6 is a flow diagram of method steps for generating an expiring user identifier, according to various embodiments; and

FIG. 7 is a flow diagram of method steps for generating an expiring user identifier based on an event-based identifier, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Various technical challenges emerge when generating network-accessible services, such as a streaming media service, for a large population of users. In some scenarios, an operator of a streaming media service shares an identifier of a user, or an identifier corresponding to events associated with a user, with external or third-party systems. For example, a user might view a media title in the streaming media service, which constitutes an event. In some cases, the occurrence of the event is provided by the streaming media service to external systems associated with third-party entities that are separate from the operator of the streaming media service. For example, the occurrence of the event can be provided to an external system linked to an entity that monitors viewership of a specific streaming media title.

In some scenarios, the event can relate to a specific user or user account within the streaming media service. The streaming media service can share an event-associated identifier that obfuscates the identity of the user. However, if the event recurs or is repeated, the external system can attempt to ascertain whether subsequent events are linked to the same user within the streaming media service, even if the identity of the user may not be directly discernible from data contained in the event provided to the external system. For example, the external system may possess information about the identity of the user because the user has a user account with the third-party system. Consequently, if subsequent events provided by the streaming media service to the external system are linked to the user and include the same identifier, then the external system can potentially associate any future activity associated with the identifier with a particular user, thereby introducing unacceptable privacy risks.

In some scenarios, one-time identifiers corresponding to a user might be used to mitigate any and all privacy concerns. For example, a one-time identifier might be used in association with an event and never be reused. However, in some scenarios, a streaming media service operator might want or need to provide an identifier related to a user and an event that is at least temporarily persistent across a limited number of uses or a specified time window. In such a scenario, a one-time identifier cannot be utilized.

Prior solutions to generating a temporary user identifier that is at least temporarily persistent involve generating a stateful temporary user identifier. In such a solution, a server generates a session for a user that includes a temporary user identifier. However, data related to the temporary user identifier, such as an expiration date, must then be tracked or stored in a data store. Each time the temporary user identifier is used, the state must be checked to determine whether expiration has occurred. Such a stateful approach imposes significant data storage and computational overheads.

To address these issues, embodiments of the disclosure provide the capability to generate an expiring user identifier that is stateless yet persistent for a specified time window. In some embodiments, the persistence of the expiring user identifier is based on a configurable time-to-life (TTL) value from which a cycle time of the expiring user identifier is generated. The cycle time can be generated based on the TTL and based on an event-based identifier corresponding to an event associated with the user. Once the cycle time expires, a new identifier corresponding to the user is generated even if all other aspects of a particular event remain unchanged.

At least one technical advantage of the disclosed techniques relative to the prior art is that the disclosed techniques enable a network-accessible service to generate an expiring user identifier that remains consistent across multiple requests or within a given time window. Additionally, the expiring user identifier also obfuscates the identity of a user or a user identifier associated with the user. Another technical advantage of the disclosed techniques is that such techniques provide a stateless mechanism to generate expiring user identifiers without requiring the tracking of user identifier states in a database or other data store. A stateless mechanism for generating expiring user identifiers reduces both the computational overhead and the data storage requirements of the network-accessible service. Reducing computational overhead and data storage requirements offers significant technical advantages, particularly in systems or services that involve a large user base. By using an expiring user identifier, additional control over the degree to which third party systems can track user activity associated with the expiring user identifier can be achieved.

These technical advantages provide one or more technological advancements over prior art approaches.

### System Overview

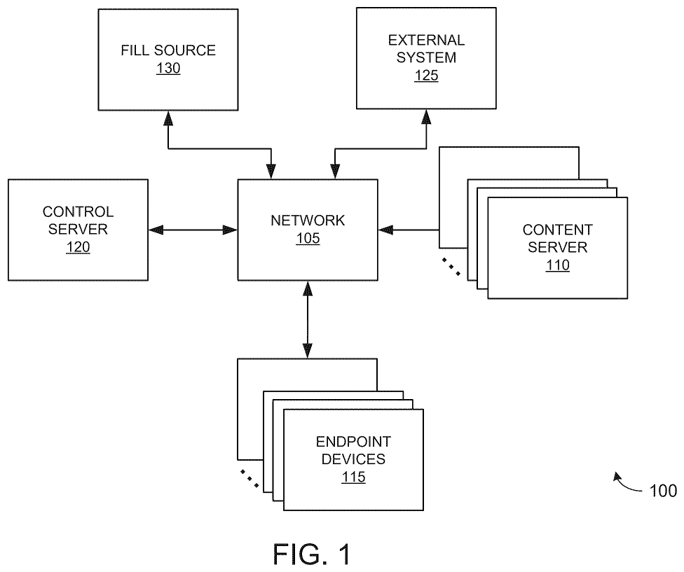

FIG. 1 illustrates a network infrastructure 100 that can be used by a network-accessible service such as a streaming media service to distribute content to content servers 110 and endpoint devices 115, according to various embodiments. As shown, the network infrastructure 100 includes content servers 110, control server 120, endpoint devices 115, and an external system 125, each of which is connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a webserver, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

The external system 125 represents one or more computing devices or servers that are associated with a service or system external to the network-accessible service. For example, the external system 125 can include one or more servers associated with a third-party system to which events corresponding to users of the streaming media service are periodically reported, such as anonymized viewing data.

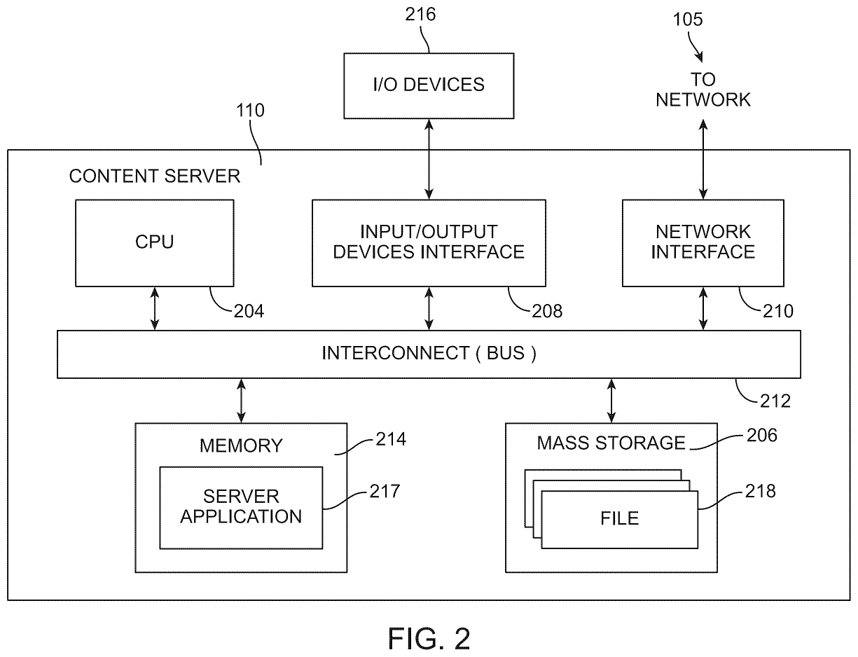

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from an endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

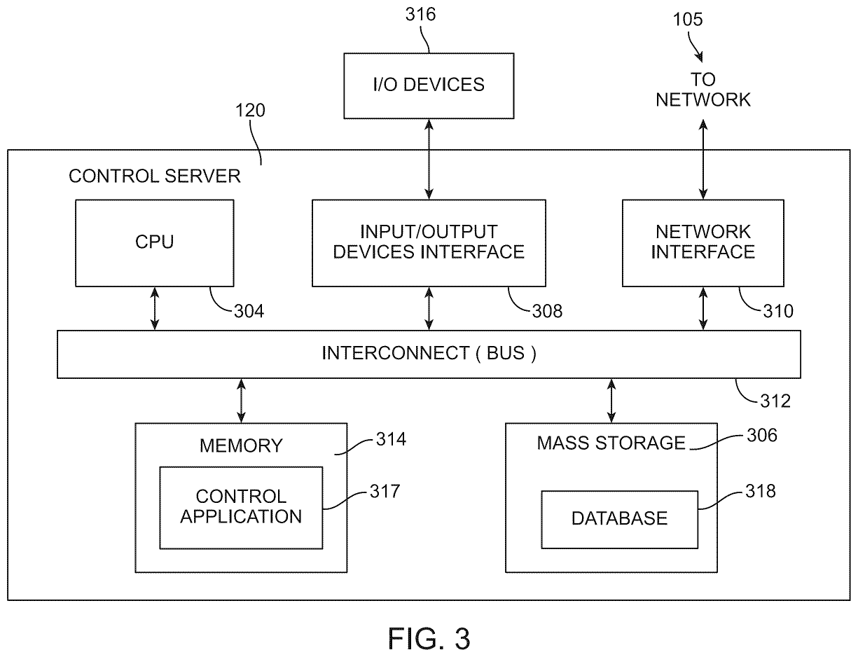

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid-state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the network infrastructure 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within network infrastructure 100, prior to storage.

Control application 317 can also monitor events occurring within a streaming media service, such as user activity. One example of such user activity includes playback events that correspond to a particular user playing back a particular media title. Control application 317 can also identify various metadata associated with playback events, such as the identity of a title, an episode, genre, release date, air date, country or origin, language, content rating, keywords, tags, and other metadata that can be stored in association with a streaming media title. Control application 317 can further determine other metadata associated with a playback event, such as a geographic region from which the playback event originated or in which the user is located, demographic information associated with the user or a user account, a referring link that the user used to initiate playback of the media title, or other metadata associated with a playback event.

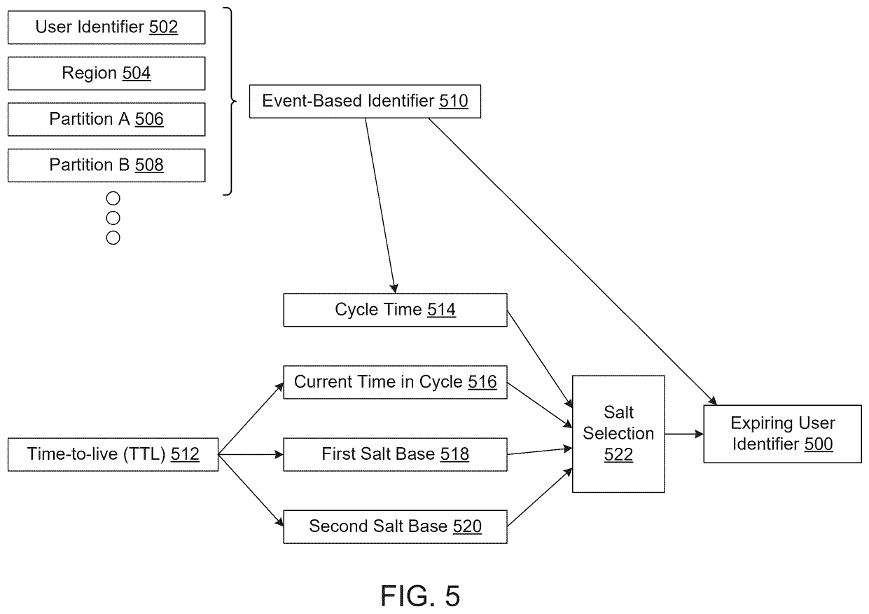

Control application 317 can generate an event-specific identifier that corresponds to the event as well as a user associated with the event. For example, if a user initiates playback of a particular streaming media title, control application 317 can generate an event-specific identifier based on the identity of the user, the selected streaming media title, and potentially other data or metadata associated with the event. Based on the event-specific identifier, the control application 317 can generate an expiring user identifier that is stateless and semi-stable based on a configurable TTL value. The expiring user identifier is semi-stable in that the expiring user identifier does not expire until a cycle time that is based on a TTL value used to generate the expiring user identifier. Control application 317 can select differing levels of stability or decay rates of expiring user identifier based on various inputs, such as an identity of the user, a region of the user, a destination with which the expiring user identifier is shared, or other aspects of an event to which the expiring user identifier corresponds. Additional detail regarding creation of expiring user identifiers is provided in connection with the discussion of FIGS. 5-7.

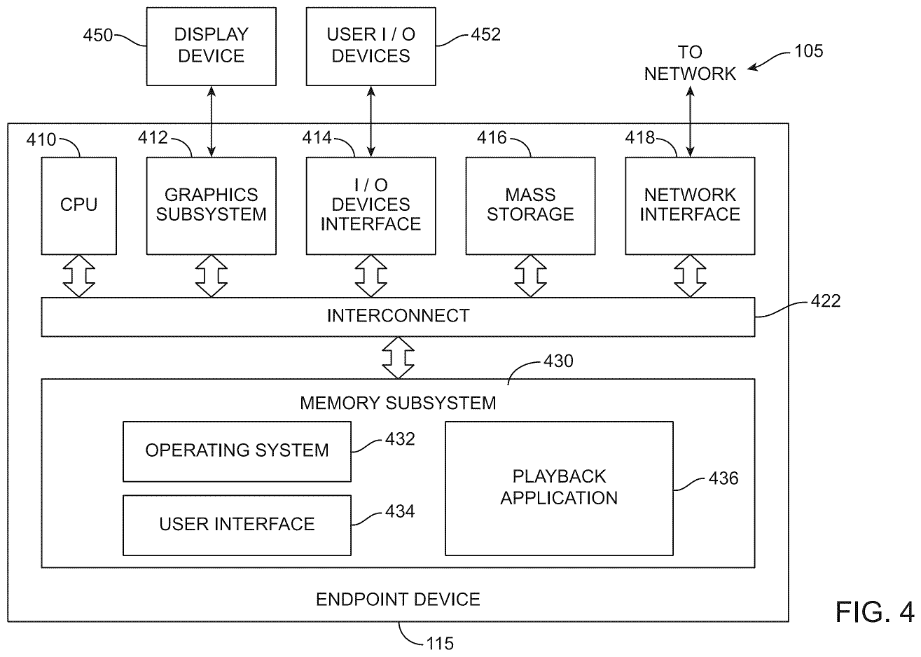

FIG. 4 is a block diagram of an endpoint device 115 that may be implemented in conjunction with the network infrastructure 100 of FIG. 1, according to various embodiments of the present invention. As shown, endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422. The network interface 418 supports connections using different network protocols, such as IPv4, IPv6, and other IP-based protocols.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via the display device 450. In some embodiments, the playback application 436 is a browser executed by the endpoint device 115. For example, the browser can access one or more content pages via a network, such as the Internet, that are associated with a streaming media service. The streaming media service generates one or more content pages that include content such as images, text, videos, audio, and other content that is rendered on the endpoint device 115 by the browser.

### Generating an Expiring User Identifier

FIG. 5 illustrates an example of how control application 317 can generate an expiring user identifier 500, according to various embodiments. The expiring user identifier 500 corresponds to an event occurring in a network-accessible service, such as a streaming media service. As described above, control application 317 can monitor events occurring within the streaming media service and relate the events to particular users. In some examples, the control application 317 reports information about such events to one or more external systems 125. An example of such an event is a playback event representing a particular user or user account initiating playback of a media title. Another example of an event monitored by control application 317 is a user pausing, stopping, completing, or seeking playback of a media title in the streaming media service. Other examples of events include network quality or playback quality telemetry events or user interaction events, such as interaction with user interface elements, recommendations, or other aspects of a user interface.

Accordingly, again, control application 317 can be configured to report information about events occurring within a streaming media service to an external system 125. Control application 317 can generate an expiring user identifier 500 that can be included along with other information or metadata about the event. The expiring user identifier 500 can comprise a semi-stable, partitioned identifier that can be configured with varying custom decay rates depending upon one or more aspects of an event to which the expiring user identifier 500 corresponds. A partition represents a category associated with the event, such as a geographic region associated with a user, a geographic region associated with the event, an identity of an external system 125 to which the event is being reported or sent, or other categories or subcategories associated with the external system 125 to which the event is being reported. A decay rate represents how persistent the expiring user identifier 500 is. In other words, the decay rate represents an amount of time after which the expiring user identifier 500 is cycled to a new expiring user identifier 500 if the inputs to the expiring user identifier 500 remain unchanged. During a given window of time represented by a cycle time, subsequent operations to generate an expiring user identifier 500 using the same inputs results in the same value of the expiring user identifier 500 being generated. Upon expiration of a cycle time, the value of the expiring user identifier 500 would change even if the same inputs are otherwise used to generate the expiring user identifier 500.

Accordingly, control application 317 first identifies partitions that are associated with the event. One of the partitions includes a user identifier 502 of the user within the streaming media service. The user identifier 502 uniquely identifies a user among a population or plurality of users of the streaming media service. In the example of FIG. 5, another partition includes a region 504 associated with the event, such as a geographic region associated with the user or with the event within the streaming media service. Additionally, as an illustrative example, partition A 506 and partition B 508 correspond to other aspects of an event that can be used to generate an event-based identifier 510 corresponding to the event. These other aspects can include information about the external system 125 to which an event is being reported or other data or metadata associated with the event.

Accordingly, control application 317 can generate an event-based identifier 510, based on the user identifier 502, region 504, partition A 506, and partition B 508 using a hash function. As an illustrative scenario, if the control application 317 utilized the event-based identifier 510 to report information about the event to an external system 125, the event-based identifier 510 would remain unchanged regardless of when the event-based identifier 510 is generated using a hash function. Accordingly, an external system 125 could potentially determine that the event-based identifier 510 corresponds to a particular user within the streaming media service even though the event-based identifier 510 does not directly include information about the identity of the user.

Accordingly, the control application 317 generates various values at request time from which an expiring user identifier 500 is subsequently generated, where the expiring user identifier 500 obfuscates the event-based identifier 510 and, as a result, the identity of the user. The values are based on a current time as well as a configurable time-to-live (TTL) value, or TTL 512, that determines a decay rate, or a cycle time, associated with an expiring user identifier 500. First, the control application 317 generates a cycle time 514 that represents a time period after which a respective expiring user identifier 500 should be cycled. In other words, the cycle time 514 represents a decay rate associated with an expiring user identifier 500. In one embodiment, the value of TTL 512 represents a complete cycle during which two different expiring user identifiers 500 can be generated based on a given event-based identifier 510. In one implementation, the cycle time 514 represents a number between zero and the value of TTL 512 and is used by control application 317 to select between one of two salts for subsequent generation of the expiring user identifier 500. The control application 317 generates the cycle time 514 using a function or mathematical operation that receives as an input the event-based identifier 510 and outputs a number between zero and the value of TTL 512. In some embodiments, the control application 317 adds or subtracts an amount of time from the value of TTL 512. In other words, the control application 317 can apply a noise function to the value of TTL 512. The amount of time added or subtracted from the value of TTL 512 can be randomly selected so that an external system 125 receiving an expiring identifier 500 is less able to predict when the expiring identifier 500 will cycle to a new value.

The control application 317 also generates additional values based on the value of TTL 512. The control application 317 determines, based on the current time and the value of TTL 512, a current time in cycle 516. In one embodiment, current time in cycle 516 can be calculated by taking the current time in seconds modulo the value of TTL 512. The current time in cycle 516 is also later used to select between one of two salts for subsequent generation of the expiring user identifier 500.

Control application 317 also generates two base values that are used to generate two different salts that are used to generate the expiring user identifier 500. Control application 317 generates a first salt base value 518 and a second salt base value 520 based on the value of TTL 512. In one example, the first salt base value 518 is generated by dividing the current time in seconds by the value of TTL 512 and performing a floor operation on the result. The second salt base value 520 can be generated by dividing the current time in seconds by the value of TTL 512 and performing a ceiling operation on the result. By basing the salt base values on the current time, a new salt base value is selected as the current time progresses, but the salt base value remains stable within a given TTL window. In other words, by basing the salt base values on a linearly and strictly increasing value, such as time, the salt base values remain stable and consistent within a given TTL window. Prior to or until the expiration of the cycle time 514 within a given TTL window, the first salt base value 518 can be used. On or after expiration of the cycle time 514 within a given TTL window, the second salt base value 520 can be used.

The cycle time 514, current time in cycle 516, first salt base value 518, and second salt base value 520 are then used by control application 317 to generate and select between two salts at salt selection 522. A salt is used to generate the expiring user identifier 500. In one embodiment, control application 317 compares the value of cycle time 514 and current time in cycle 516. If cycle time 514 is greater than current time in cycle 516, then first salt base value 518 is selected as the basis to generate a salt. If cycle time 514 is less than current time in cycle 516, then second salt base value 520 is selected as the basis to generate the salt. In alternative embodiments, the reverse comparison can be used. In other words, the value of cycle time 514 or current time in cycle 516 is compared to a threshold value to select one of the first salt base value 518 or second salt base value 520. Additionally, any other mechanism to select between first salt base value 518 and second salt base value 520 can be chosen so long as the selection is repeatable based on a current time.

In one embodiment, the salt is generated by using whichever is selected from first salt base value 518 and second salt base value 520 as the basis for generating a salt value. For example, a random string is added to the first salt base value 518 or second salt base value 520. As another example, first salt base value 518 or second salt base value 520 is provided as an input to a hash function that generates a salt value.

Once control application 317 generates a salt value, the salt value is provided along with the event-based identifier 510 to a hash function to generate the expiring user identifier 500. Accordingly, because the methodology utilized by control application 317 to generate the expiring user identifier 500 is based on a current time as well as a TTL 512, the expiring user identifier 500 can be reliably and reproducibly generated in a stateless manner. Additionally, because the expiring user identifier 500 is based on a user identifier of the user within the network-accessible service, the expiring user identifier 500 uniquely identifies the user but is only temporarily persistent due to the temporal inputs, such as a current time and a TTL, that are also utilized to generate the expiring user identifier 500.

### Providing an Expiring User Identifier to an External System in Response to an Event

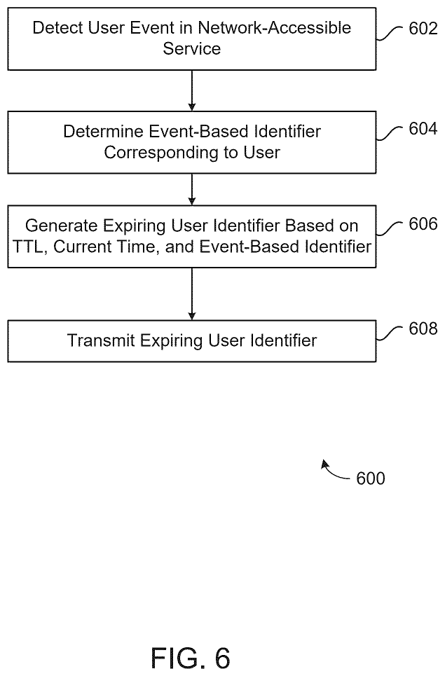

FIG. 6 is a flow diagram of method steps for generating an expiring user identifier 500, according to various embodiments. The expiring user identifier 500 is generated in response to an event occurring within a network-accessible service, such as a streaming media service. Although the method steps are described in conjunction with the systems of FIGS. 1-5, persons skilled in the art will understand that any system configured to perform the method steps, in any order, is within the scope of the present invention.

As shown, a method 600 begins at step 602, where a control server 120, or the control application 317 executed by the control server 120, detects a user event within a network-accessible service for which an expiring user identifier 500 is required. The event can correspond to an event that the control server 120 reports to an external system 125, such as a playback event associated with a streaming media title. The control server 120 receives a request from an endpoint device 115 to access a network-accessible service, such as a streaming media service. In one example, a user of the endpoint device 115 navigates to or is directed to a uniform resource locator (URL) in a browser application that is associated with the network-accessible service. Another example of an event monitored by control application 317 is a user pausing, stopping, completing, or seeking playback of a media title in the streaming media service. Other examples of events include network quality or playback quality telemetry events, or user interaction events, such as interaction with user interface elements, recommendations, or other aspects of a user interface.

The method 600 continues at step 604, where the control server 120 determines or generates an event-based identifier 510 based on the event detected at step 602. The event-based identifier 510 is based on a user identifier of the user within the network-accessible service. The user identifier uniquely identifies the user among a population of users of the network-accessible service. However, the user identifier, in many embodiments, is persistent in that the user identifier does not change over time. Accordingly, sharing the user identifier with an external system 125 creates privacy concerns that are alleviated by generating an expiring user identifier 500. The event-based identifier is also based on one or more partitions or parameters that describe other aspects of the event detected at step 602. As noted above, the partitions or parameters can include location metadata or information about the external system 125 to which the expiring user identifier 500 is being provided.

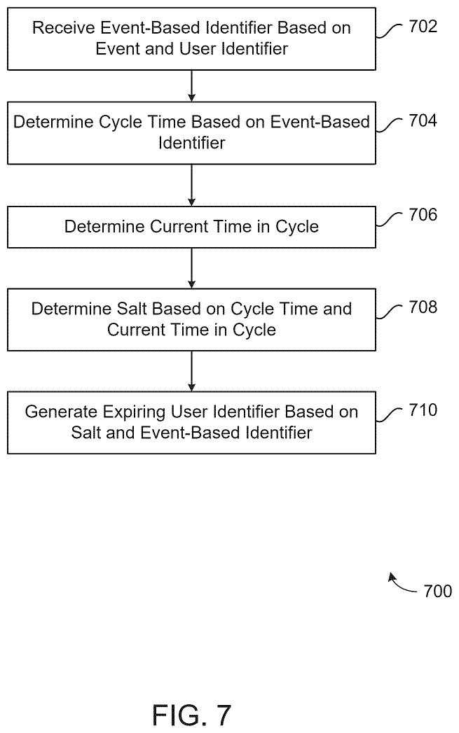

The method 600 continues at step 606, where control server 120 generates the expiring user identifier 500 based on the event-based identifier 510 generated by step 604, a TTL value associated with the event-based identifier 510, and a current time. The TTL value and current time can be expressed in seconds in some embodiments. The TTL value can also be configurable based on the identity of the user or the identity of an external system 125 to which the expiring user identifier 500 is being provided. For example, an expiring user identifier 500 being shared with a first external system 125 can be configured with a longer TTL than an expiring user identifier 500 being shared with a second external system 125, even if all other aspects associated with the event or the event-based identifier 510 are the same or similar. The steps for generating the expiring user identifier 500 are described in further detail above and in the discussion of FIG. 7 below.

The method 600 continues at step 608, where control server 120 transmits the expiring user identifier 500 generated by step 606 to an external system 125. In some embodiments, additional content is also provided to the external system 125 along with the expiring user identifier 500, such as request data or other metadata. Providing the expiring user identifier 500 causes the external system 125 to take one or more actions in response to receiving the expiring user identifier 500. For example, the external system 125 can log the event or provide a response to the control server 120, which can in turn be provided to an endpoint device 115 associated with the user. For example, the response provided to the control server 120 can include content related to the event associated with the expiring user identifier 500. The content can be displayed to the user by the endpoint device 115.

### Generating an Expiring User Identifier

FIG. 7 is a flow diagram of method steps for generating an expiring user identifier 500 based on an event-based identifier 510, according to various embodiments. The method steps described in connection with FIG. 7 illustrate an example of how an expiring user identifier 500 is generated, such as the expiring user identifier 500 generated at step 606 of the method 600 of FIG. 6. Although the method steps are described in conjunction with the systems of FIGS. 1-5, persons skilled in the art will understand that any system configured to perform the method steps, in any order, is within the scope of the present invention.

As shown, a method 700 begins at step 702, where the control server 120 or the control application 317 receives an event-based identifier 510 based on an event occurring within a network-accessible service and a user identifier associated with a user or user account. As noted above, the event-based identifier 510 is based on a user identifier of the user within the network-accessible service. The event-based identifier is also based on one or more partitions or parameters that describe other aspects of an event occurring with a network-accessible service.

At step 704, the control server 120, or the control application 317 executed by control server 120, determines a cycle time 514 that represents a time period after which a respective expiring user identifier 500 should be cycled. In other words, the cycle time 514 represents a decay rate associated with an expiring user identifier 500. In one embodiment, the value of TTL 512 represents a complete cycle during which two different expiring user identifiers 500 are generated based on a given event-based identifier 510. In one implementation, the cycle time 514 represents a number between zero and the value of TTL 512 and is used by control application 317 to select between one of two salts for subsequent generation of the expiring user identifier 500. The control application 317 generates the cycle time 514 using a function or mathematical operation that receives as an input the event-based identifier 510 and outputs a number between zero and the value of TTL 512.

At step 706, control application 317 determines a current time in cycle 516. The current time in cycle 516 can be calculated by taking the current time in seconds modulo the value of TTL 512. The current time in cycle 516 is also later used to select between one of two salts for subsequent generation of the expiring user identifier 500.

At step 708, control application 317 determines a salt value that is used to generate the expiring user identifier 500. As noted above, in some embodiments, control application 317 generates two base values that are used to generate two different salts. One of the salts is selected to generate the expiring user identifier 500. Control application 317 generates a first salt base value 518 and a second salt base value 520 based on the value of TTL 512. In one example, the first salt base value 518 is generated by dividing the current time in seconds by the value of TTL 512 and performing a floor operation on the result. The second salt base value 520 can be generated by dividing the current time in seconds by the value of TTL 512 and performing a ceiling operation on the result. By basing the salt base values on the current time, a new salt base value is selected as the current time progresses, but the salt base value remains stable within a given TTL window. In one embodiment, control application 317 selects one of the two salt values based on the current time in cycle 516 and the cycle time 514. In one embodiment, control application 317 compares the value of cycle time 514 and current time in cycle 516. If cycle time 514 is greater than current time in cycle 516, then first salt base value 518 is selected as the basis to generate a salt. If cycle time 514 is less than current time in cycle 516, then second salt base value 520 is selected as the basis to generate the salt. In alternative embodiments, the reverse comparison can be used. Additionally, any other mechanism to select between first salt base value 518 and second salt base value 520 can be chosen, provided the selection is repeatable based on a current time.

In one embodiment, the salt is generated by using whichever is selected from first salt base value 518 and second salt base value 520 as the basis for generating a salt value. For example, a random string is added to the first salt base value 518 or second salt base value 520. As another example, first salt base value 518 or second salt base value 520 is provided as an input to a hash function that generates a salt value.

At step 710, control application 317 generates the expiring user identifier 500 based on the cycle time 514, the salt, and the event-based identifier 510. Once control application 317 generates a salt value, the salt value is provided along with the event-based identifier 510 to a hash function to generate the expiring user identifier 500. Accordingly, because the methodology utilized by control application 317 to generate the expiring user identifier 500 is based on a current time as well as a TTL 512, the expiring user identifier 500 can be reliably and reproducibly generated in a stateless manner. Additionally, because the expiring user identifier 500 is based on a user identifier of the user within the network-accessible service, the expiring user identifier 500 uniquely identifies the user but is only temporarily persistent due to the temporal inputs, such as a current time and a TTL, that are also utilized to generate the expiring user identifier 500.

In sum, a control server is configured to generate an expiring user identifier that is associated with an event occurring within a network-accessible service, such as a streaming media service. The expiring user identifier is generated based on a current time and a configurable time-to-live (TTL) value. The expiring user identifier is temporarily persistent over a cycle time that is generated based on the TTL value. The expiring user identifier is also stateless because it can be generated at runtime based on the current time, parameters associated with an event, and the TTL value.

At least one technical advantage of the disclosed techniques relative to the prior art is that the disclosed techniques enable a network-accessible service to generate an expiring user identifier that remains consistent across multiple requests or within a given time window. Additionally, the expiring user identifier also obfuscates the identity of a user or a user identifier associated with the user. Another technical advantage of the disclosed techniques is that such techniques provide a stateless mechanism to generate expiring user identifiers without requiring the tracking of user identifier states in a database or other data store. A stateless mechanism for generating expiring user identifiers reduces both the computational overhead and the data storage requirements of the network-accessible service. Reducing computational overhead and data storage requirements offers significant technical advantages, particularly in systems or services that involve a large user base.

These technical advantages provide one or more technological advancements over prior art approaches.
1. In some embodiments, a computer-implemented method for generating expiring user identifiers comprises receiving an event-based identifier that uniquely identifies a user among a plurality of users, determining a time-to-live (TTL) based on the event-based identifier, generating a salt based on a current time and the TTL, providing, to a hash function, the event-based identifier and the salt to generate an expiring user identifier, and transmitting the expiring user identifier to at least one computing device, wherein the expiring user identifier obfuscates the event-based identifier from the at least one computing device and wherein a new expiring user identifier based on the event-based identifier has a same value as the expiring user identifier during at least a portion of the TTL.
2. The computer-implemented method of clause 1, further comprising determining a cycle time of the expiring user identifier based on the event-based identifier, wherein the cycle time comprises a number between zero and a value of the TTL.
3. The computer-implemented method of clauses 1 or 2, wherein the cycle time is determined based on a first mathematical operation that receives the event-based identifier and outputs the number between zero and the value of the TTL.
4. The computer-implemented method of any of clauses 1-3, wherein generating the salt further comprises performing a second mathematical operation on a value of the TTL, wherein the second mathematical operation outputs a first salt base value and a second salt base value.
5. The computer-implemented method of any of clauses 1-4, wherein the first salt base value and the second salt base value are based on dividing the current time with the value of the TTL.
6. The computer-implemented method of any of clauses 1-5, wherein the salt further comprises selecting one of the first salt base value or the second salt base value based on the current time within a cycle and a cycle time associated with the expiring user identifier, and generating the salt based on the selected one of the first salt base value and the second salt base value.
7. The computer-implemented method of any of clauses 1-6, wherein generating the salt comprises combining another value with the selected one of the first salt base value and the second salt base value.
8. The computer-implemented method of any of clauses 1-7, further comprising cycling the expiring user identifier based on a comparison of the current time within the cycle and a threshold value, the threshold value comprising a number between zero and the cycle time.
9. The computer-implemented method of any of clauses 1-8, wherein the cycle time is generated based on the event-based identifier.
10. The computer-implemented method of any of clauses 1-9, further comprising applying a noise function to a value of the TTL, the noise function modifying the value of the TTL.
11. The computer-implemented method of any of clauses 1-10, wherein the noise function adjusts the value of the TTL by a random amount.
12. In some embodiments, one or more non-transitory computer-readable media include instructions that, when executed by one or more processors, cause the one or more processors to expiring user identifiers by performing the steps of receiving an event-based identifier that uniquely identifies a user among a plurality of users, determining a time-to-live (TTL) based on the event-based identifier, generating a salt based on a current time and the TTL, providing, to a hash function, the event-based identifier and the salt to generate an expiring user identifier, and transmitting the expiring user identifier to at least one computing device to cause the at least one computing device to perform at least one action wherein the expiring user identifier obfuscates the event-based identifier from the at least one computing device and wherein a new expiring user identifier based on the event-based identifier has a same value as the expiring user identifier during at least a portion of the TTL.
13. The one or more non-transitory computer-readable media of clause 12, wherein the event-based identifier comprises a user identifier of a user account within a network-accessible service.
14. The one or more non-transitory computer-readable media of clauses 12 or 13, wherein the event-based identifier is based on the user identifier and metadata associated with an event occurring within the network-accessible service.
15. The one or more non-transitory computer-readable media of any of clauses 12-14, wherein the steps further comprise determining a cycle time of the expiring user identifier based on the event-based identifier, wherein the cycle time comprises a number between zero and a value of the TTL.
16. The one or more non-transitory computer-readable media of any of clauses 12-15, wherein the cycle time is determined based on a first mathematical operation that receives the event-based identifier and outputs the number between zero and the value of the TTL.
17. The one or more non-transitory computer-readable media of any of clauses 12-16, wherein generating the salt further comprises performing a second mathematical operation on a value of the TTL, wherein the second mathematical operation a first salt base value and a second salt base value.
18. The one or more non-transitory computer-readable media of any of clauses 12-17, wherein the first salt base value and the second salt base value are based on dividing the current time with the value of the TTL.
19. The one or more non-transitory computer-readable media of any of clauses 12-18, wherein the at least one computing device performs at least one action in response to receiving the expiring user identifier.
20. In some embodiments, a system comprises one or more memories storing instructions, and one or more processors coupled to the one or more memories that, when executing the instructions, perform the steps of receiving an event-based identifier that uniquely identifies a user among a plurality of users, determining a time-to-live (TTL) based on the event-based identifier, generating a salt based on a current time and the TTL, providing, to a hash function, the event-based identifier and the salt to generate an expiring user identifier, and transmitting the expiring user identifier to at least one computing device to cause the at least one computing device to perform at least one action wherein the expiring user identifier obfuscates the event-based identifier from the at least one computing device and wherein a new expiring user identifier based on the event-based identifier has a same value as the expiring user identifier during at least a portion of the TTL.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating expiring user identifiers, the method comprising:
receiving an event-based identifier that uniquely identifies a user among a plurality of users;
determining a time-to-live (TTL) based on the event-based identifier;
generating a salt based on a current time and the TTL;
providing, to a hash function, the event-based identifier and the salt to generate an expiring user identifier; and
transmitting the expiring user identifier to at least one computing device, wherein the expiring user identifier obfuscates the event-based identifier from the at least one computing device and wherein a new expiring user identifier based on the event-based identifier has a same value as the expiring user identifier during at least a portion of the TTL.

2. The computer-implemented method of claim 1, further comprising determining a cycle time of the expiring user identifier based on the event-based identifier, wherein the cycle time comprises a number between zero and a value of the TTL.

3. The computer-implemented method of claim 2, wherein the cycle time is determined based on a first mathematical operation that receives the event-based identifier and outputs the number between zero and the value of the TTL.

4. The computer-implemented method of claim 1, wherein generating the salt further comprises performing a second mathematical operation on a value of the TTL, wherein the second mathematical operation outputs a first salt base value and a second salt base value.

5. The computer-implemented method of claim 4, wherein the first salt base value and the second salt base value are based on dividing the current time with the value of the TTL.

6. The computer-implemented method of claim 4, wherein the salt further comprises:
selecting one of the first salt base value or the second salt base value based on the current time within a cycle and a cycle time associated with the expiring user identifier; and
generating the salt based on the selected one of the first salt base value and the second salt base value.

7. The computer-implemented method of claim 6, wherein generating the salt comprises combining another value with the selected one of the first salt base value and the second salt base value.

8. The computer-implemented method of claim 6, further comprising cycling the expiring user identifier based on a comparison of the current time within the cycle and a threshold value, the threshold value comprising a number between zero and the cycle time.

9. The computer-implemented method of claim 8, wherein the cycle time is generated based on the event-based identifier.

10. The computer-implemented method of claim 1, further comprising applying a noise function to a value of the TTL, the noise function modifying the value of the TTL.

11. The computer-implemented method of claim 10, wherein the noise function adjusts the value of the TTL by a random amount.

12. One or more non-transitory computer-readable media including instructions that, when executed by one or more processors, cause the one or more processors to expiring user identifiers by performing the steps of:
receiving an event-based identifier that uniquely identifies a user among a plurality of users;
determining a time-to-live (TTL) based on the event-based identifier;
generating a salt based on a current time and the TTL;
providing, to a hash function, the event-based identifier and the salt to generate an expiring user identifier; and
transmitting the expiring user identifier to at least one computing device to cause the at least one computing device to perform at least one action wherein the expiring user identifier obfuscates the event-based identifier from the at least one computing device and wherein a new expiring user identifier based on the event-based identifier has a same value as the expiring user identifier during at least a portion of the TTL.

13. The one or more non-transitory computer-readable media of claim 12, wherein the event-based identifier comprises a user identifier of a user account within a network-accessible service.

14. The one or more non-transitory computer-readable media of claim 13, wherein the event-based identifier is based on the user identifier and metadata associated with an event occurring within the network-accessible service.

15. The one or more non-transitory computer-readable media of claim 12, wherein the steps further comprise determining a cycle time of the expiring user identifier based on the event-based identifier, wherein the cycle time comprises a number between zero and a value of the TTL.

16. The one or more non-transitory computer-readable media of claim 15, wherein the cycle time is determined based on a first mathematical operation that receives the event-based identifier and outputs the number between zero and the value of the TTL.

17. The one or more non-transitory computer-readable media of claim 12, wherein generating the salt further comprises performing a second mathematical operation on a value of the TTL, wherein the second mathematical operation a first salt base value and a second salt base value.

18. The one or more non-transitory computer-readable media of claim 17, wherein the first salt base value and the second salt base value are based on dividing the current time with the value of the TTL.

19. The one or more non-transitory computer-readable media of claim 12, wherein the at least one computing device performs at least one action in response to receiving the expiring user identifier.

20. A system comprising:
one or more memories storing instructions; and
one or more processors coupled to the one or more memories that, when executing the instructions, perform the steps of:
receiving an event-based identifier that uniquely identifies a user among a plurality of users;
determining a time-to-live (TTL) based on the event-based identifier;
generating a salt based on a current time and the TTL;
providing, to a hash function, the event-based identifier and the salt to generate an expiring user identifier; and
transmitting the expiring user identifier to at least one computing device to cause the at least one computing device to perform at least one action wherein the expiring user identifier obfuscates the event-based identifier from the at least one computing device and wherein a new expiring user identifier based on the event-based identifier has a same value as the expiring user identifier during at least a portion of the TTL.
